(19) United States
(12) Patent Application Publication
(10) Pub. No.: US 2024/0248744 A1
(43) Pub. Date: Jul. 25, 2024

(54) SYSTEMS AND METHODS FOR OFFLOADING GUEST TASKS TO A HOST SYSTEM

(71) Applicant: Red Hat, Inc., Raleigh, NC (US)

(72) Inventor: Bandan Das, Burlington, MA (US)

(21) Appl. No.: 18/159,356

(22) Filed: Jan. 25, 2023

(51) Int. Cl. G06F 9/455

(52) U.S. Cl. CPC G06F 9/45558; G06F 2009/4557; G06F 2009/45583

(57) ABSTRACT

Systems and methods for offloading guest tasks to a host system. An example method may comprise receiving, by a host computer system running a virtual machine, a request initiated by a first vCPU of the virtual machine to allocate, to the virtual machine, a second vCPU for executing a specified task; creating, based on the state of the virtual machine, a processing thread to implement the second vCPU; and executing the specified task by the second vCPU.

### TECHNICAL FIELD

The present disclosure is generally related to virtualized computer systems, and more particularly, to offloading guest tasks to a host system.

### BACKGROUND

Virtualization herein shall refer to abstraction of some physical components into logical objects in order to allow running various software modules, for example, multiple operating systems, concurrently and in isolation from other software modules, on one or more interconnected physical computer systems. Virtualization allows, for example, consolidating multiple physical servers into one physical server running multiple VMs in order to improve the hardware utilization rate.

Virtualization may be achieved by running a software layer, often referred to as “hypervisor,” above the hardware and below the VMs. A hypervisor may run directly on the server hardware without an operating system beneath it or as an application running under a traditional operating system. A hypervisor may abstract the physical layer and present this abstraction to VMs to use, by providing interfaces between the underlying hardware and virtual devices of VMs.

Processor virtualization may be implemented by the hypervisor scheduling time slots on one or more physical processors for a virtual machine, rather than a virtual machine actually having a dedicated physical processor. Memory virtualization may be implemented by employing a page table (PT) which is a memory structure translating virtual memory addresses to physical memory addresses. Device and input/output (I/O) virtualization involves managing the routing of I/O requests between virtual devices and the shared physical hardware.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example computing system that provides memory isolation for a computing process, in accordance with one or more aspects of the present disclosure;

FIG. 2 depicts a block diagram illustrating components and modules of an example computer system, in accordance with one or more aspects of the present disclosure;

FIG. 3 depicts a flow diagram of an example method for offloading a guest task to a host system, in accordance with one or more aspects of the present disclosure;

FIG. 4 depicts a block diagram of an example computer system in accordance with one or more aspects of the present disclosure;

FIG. 5 depicts a flow diagram of another example method for offloading a guest task to a host system, in accordance with one or more aspects of the present disclosure; and

FIG. 6 depicts a block diagram of an illustrative computing device operating in accordance with the examples of the present disclosure.

### DETAILED DESCRIPTION

Described herein are systems and methods for offloading guest tasks to a host system. In some system, a hypervisor manages execution of virtual machines on a host machine. This includes provisioning resources of a physical central processing unit (“CPU”) to each virtual machine (“VM”) running on the host machine. Provisioning the physical CPU resources may include assigning one or more virtual central processing units (“vCPU”) with each VM. A vCPU may be implemented by an execution thread that is scheduled to run on a physical CPU of the host.

Hot-plugging involves the process of enabling or disabling devices, such as CPUs, while a VM is running. In an illustrative example, during a boot sequence, a VM can be provisioned with a certain number of CPUs. During operation, the VM can be initially restricted to a lower amount of the provisioned CPUs, while the remaining CPUs can be, for example, reserved for the host or other VMs. When the VM requires additional computing power, the hypervisor may assign one or more of the reserved CPUs. For example, a VM can be booted with six CPUs, initially assigned (e.g., granted access to) four of the CPUs, and the hypervisor can assign (via hot-plugging) the two reserved CPUs when needed. This allows the hypervisor to improve management of its limited computing resources in a multi-VM environment.

However, in some systems, a VM cannot hot-plug CPUs that the VM has not been booted with. That is, if the VM has been initially booted with six CPUs, the VM may not be capable of hot-plugging a seventh vCPU. This deficiency may create latency issues for the VM. For example, in situations where an underutilized hypervisor has idle CPUs not assigned to a VM, and the VM desires computing resources beyond its initial allocation of CPUs, the hypervisor is unable to assign the idle CPUs to the VM.

Aspects of the present disclosure address the above and other deficiencies by providing technology that allows a computing process (e.g., a VM) to offload one or more tasks to a host system (e.g., a hypervisor). In particular, aspects of the present disclosure enable the hypervisor to provide the VM with physical processing resources (e.g., one or more virtual CPUs) that the VM was not initially assigned. In some implementations, a hypervisor may boot a VM and assign, to the VM, a certain amount CPUs. Each CPU may execute one or more vCPUs. During operation, the VM may request that the hypervisor execute a particular task on behalf of the VM (referred to as an offloading operation). In one example, a vCPU assigned to the VM may execute apthread create function, which starts a new thread in the calling process by invoking the function whose address is passed as an argument to pthread create. The task can be capable of being executed (by a vCPU) independent of or in parallel with other tasks (e.g., a POSIX thread). To issue the request, the VM may load the memory address (e.g., guest physical address) of the task to a specific register and execute a VM function to alert the hypervisor of the offload request. The VM function may be a privileged processor operation that can be invoked by the VM without performing a VM exit. A VM exit is a hardware event allowing the hypervisor to preempt execution of a running VM in response to a certain triggering condition, such as, for example, execution of a privileged instruction. Therefore, the VM function allows the VM to avoid one or more context switches that would be associated with the VM exit.

Responsive to receiving the request, the hypervisor may identify an idle CPU that has neither previously been assigned to the VM nor been scheduled to be assigned to another VM. The hypervisor may identify the idle CPU by viewing the scheduler managed by the hypervisor. The hypervisor may then utilize this available CPU to run a processing thread implementing a new vCPU that is assigned to the VM for executing the task. In some implementations, the hypervisor may initiate a timer reflecting the maximum amount of time the available CPU is to be assigned to the VM. The hypervisor may then copy the current state of the VM to a shared guest memory location. In particular, the hypervisor and the VM may agree upon a shared memory location for communicating the task (process) states. The address of this shared memory location can be identified by the VM prior to the VM (via a vCPU) requesting that the hypervisor execute the particular task. Once the timer expires, the hypervisor can save the state of the offloaded task to the shared guest memory location and then notify the vCPU (of the VM) that requested this service initially. This vCPU may then read the state of the offloaded task and merge (e.g., using, for example, the pthread_join function) the offloaded task with its current task or process.

While the offloaded task is being executed, the VM may execute other tasks on its assigned processing resources. Once the offloaded task is executed, the hypervisor may store the results of the executed task in the shared guest memory location. The hypervisor may erase the temporary vCPU and mark the physical CPU as available.

Accordingly, aspects of the present disclosure reduce overall processing time and effectively manage underutilized resources by enabling a host system to process tasks on behalf of a VM.

Various aspects of the above referenced methods and systems are described in details herein below by way of examples, rather than by way of limitation. The examples provided below discuss a computer system where the computing processes may be managed by aspects of a kernel, a hypervisor, a host operating system, a virtual machine, or a combination thereof. In other examples, the computing processes may be performed in a computer system that is absent a hypervisor or other hardware virtualization features (e.g., virtual machines) discussed below.

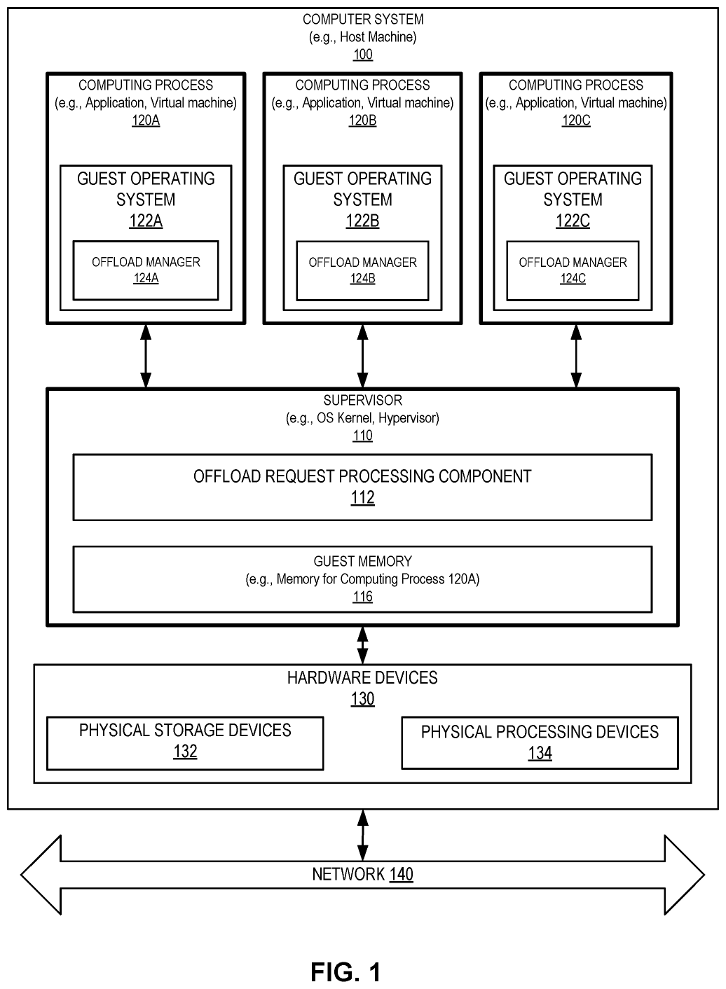

FIG. 1 depicts an illustrative architecture of elements of a computing system 100, in accordance with an embodiment of the present disclosure. Computing system 100 may be a single host machine or multiple host machines arranged in a heterogeneous or homogenous group (e.g., cluster) and may include one or more rack mounted servers, workstations, desktop computers, notebook computers, tablet computers, mobile phones, palm-sized computing devices, personal digital assistants (PDAs), etc. It should be noted that other architectures for computing system 100 are possible, and that the implementation of a computing system utilizing embodiments of the disclosure are not necessarily limited to the specific architecture depicted. In one example, computing system 100 may be a computing device implemented with x86 hardware. In another example, computing system 100 may be a computing device implemented with PowerPC®, SPARC®, or other hardware. In the example shown in FIG. 1, computing system 100 may include a supervisor 110, computing processes 120A-C, computing resources 130, and a network 140.

Supervisor 110 may manage the execution of one or more computing processes and provide the computing processes with access to one or more underlying computing devices (e.g., hardware or virtualized resources). Supervisor 110 may be a kernel and may be a part of an operating system, hypervisor, or a combination thereof. Supervisor 110 may interact with hardware devices 130 and provide hardware virtualization, operating-system virtualization, other virtualization, or a combination thereof. Hardware virtualization may involve the creation of one or more virtual machines that emulate an instance of a physical computing machine. Operating-system-level virtualization may involve the creation of one or more containers that emulate an instance of an operating system. In one example, supervisor 110 may be part of a non-virtualized operating system that is absent hardware virtualization and operating-system-level virtualization and each of the computing processes 120A-C may be an application process managed by the non-virtualized operating system. In another example, supervisor 110 may be a hypervisor or include hypervisor functionality and each of computing processes 120A-C may be or execute within a separate virtual machine or container. In either example, the supervisor may be implemented as part of a kernel and execute as one or more processes in kernel space (e.g., privileged mode, kernel mode, root mode).

In the example, shown in FIG. 1, supervisor 110 may include offload request processing component 112 and index table 114. Offload request processing component 112 may enable supervisor 110 to process offload requests, received from computing processes 120A-C, to offload tasks to a processing resource (e.g., a CPU, a vCPU, etc.) not assigned to the computing process 120A-C. In some implementations, in response to detecting an offload request, offload request processing component 112 may perform one or more processes, including identifying an available processing device (e.g., CPU), initiating a time-out timer for the available processing device, saving an execution state of computing process 120A-C, creating a vCPU to execute the task on the CPU, storing the results of the task, and communicating the results to computing process 120A-C. The execution state of computing process 120A-C may include one or more of the memory state of computing process 120A-C, the vCPU state of computing process 120A-C, the connectivity state of computing process 120A-C, etc.

Invoking, by computing process 120A-C, a VM function (e.g., VMFUNC) may subsequently send a notification to the supervisor to initiate execution of the privileged instruction without causing a VM exit. That is, the VM function may be a privileged processor operation that can be invoked by a computing process without performing a VM exit. Therefore, the VM function may avoid one or more context switches associated with the VM exit.

In some implementations, invoking a VM function may switch a page table pointer (e.g., Extended Page Table Pointer (EPTP)) from a guest page table structure (e.g., a guest page table that includes a set of records, each record mapping a guest virtual address to a guest physical address) to another page table, which includes a listing of elevated instructions. VM functions may be enabled and configured, by supervisor 110, by the settings of certain fields in a computing process data structure. The computing process may invoke the VM function by using a special ISA-dependent instruction (e.g., VMFUNC) in combination with a certain processor register (e.g., EAX) to select the specific aspect of the VM function to be invoked. Even though the VM function code does not run with elevated privileges, it may be granted access to some privileged resources, e.g., the kernel memory or memory of other computing processes.

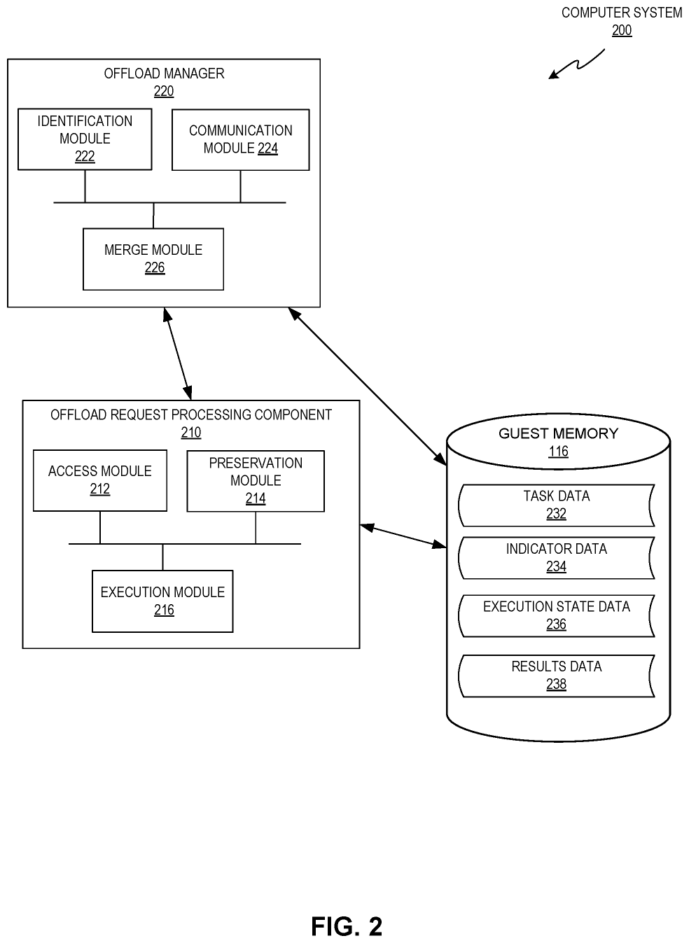

In some implementations, one VM function may be configured for processing an offload request (e.g., VMFUNC (1)), another VM function may be configured for storing the results obtained from executing the task referenced by the privileges request (e.g., VMFUNC (2)), etc. In some implementation, invoking one or more VM functions may switch the page table pointer back to the guest page table structure. For example, invoking the privileged instruction for storing the results obtained from executing the task may also trigger the pointer switch. Offload request processing component 112 is discussed in more detail in FIG. 2.

Computing processes 120A-C may include a sequence of instructions that can be executed by one or more processing devices (e.g., physical processing devices 134). A computing process may be managed by supervisor 110 or may be a part of supervisor 110. For example, supervisor 110 may execute as one or more computing processes that cooperate to manage resources accessed by computing processes 120A-C. Each computing process may include one or more processing threads, processes, other stream of executable instructions, or a combination thereof. A processing thread (“thread”) may be the smallest sequence of programmed instructions managed by supervisor 110. A process may include one or more threads and may be an instance of an executable computer program.

Computing processes 120A-C may be associated with a particular level of privilege that may be the same or similar to protection levels (e.g., processor protection rings). The privilege level may indicate an access level of a computing process to computing devices (e.g., memory, processor, or other virtual or physical resources). There may be multiple different privilege levels assigned to the computing processes 120A-C. In one example, the privilege levels may correspond generally to a user mode (e.g., reduced privilege mode, non-root mode, non-privileged mode) and a supervisor mode (e.g., enhanced privilege mode, kernel mode, root mode). The computing process executing in user mode may access resources assigned to the computing processes and may be restricted from accessing resources associated with kernel space or with another user space process (e.g., other portion of user space). For example, each computing process may have its own address space protected from other computing processes. The supervisor mode may enable the computing process to access resources associated with the kernel space and the user space. In other examples, there may be a plurality of privilege levels, and the privilege levels may include a first level (e.g., ring 0) associated with a supervisor/kernel, a second and third level (e.g., ring 1-2), and a fourth level (e.g., ring 3) that may be associated with user space applications.

A computing process may be referred to as a user space process when the computing process is executing with a user mode privilege level. In one example, the privilege level associated with a computing process may change during execution and a computing process executing in user space (e.g., userland) may request and be subsequently granted enhanced privileges by supervisor 110. Modifying the privilege level is often associated with a context switch (e.g., system call or hypercall).

In some implementations, computing process 120A-C may execute guest executable code that uses an underlying emulation of physical resources. The guest executable code may include one or more guest operating systems 122A-C that manage guest applications, guest device drivers, other executable code, or a combination thereof. Each computing process 120A-C may support hardware emulation, full virtualization, para-virtualization, operating system-level virtualization, or a combination thereof. Computing process 120A-C may have the same or different types of guest operating systems, such as Microsoft® Windows®, Linux®, Solaris®, etc. Computing processes 120A-C may execute guest operating systems 122A-C that manage offload manager 124A-C respectively. Offload managers 124A-C are used by way of example, be any type of device driver, application, program, etc.

In some implementations, offload manager 124A-C may be utilized for requesting supervisor 110 to schedule an unassigned processing resource (e.g., a vCPU not assigned to the respective computing process 120A-C) to execute one or more tasks on behalf of the computing process 120A-C. Once supervisor 110 temporarily schedules the unassigned processing resource, such a CPU, offload manager 124A-124C may rep ort to computing process 120A-120C the scheduling of the CPU. Accordingly, guest operating systems 122A-C may note the task is scheduled for execution on the CPU. For example, guest operating systems 122A-C may prevent execution of the task on a CPU (via a vCPU) initially provisioned to the computing process 120A-C. The features provided by offload manager 124A-C may be integrated into the operations performed by guest operating system 122A-C, respectively. The features of offload manager 124A-C are discussed in more detail below in the computer system of FIG. 2.

Guest memory 116 may be a portion of virtual or physical memory that is assigned to a particular computing process (e.g., 120A). The guest memory may be managed by supervisor 110 and may be segregated into assigned guest memory (e.g., memory assigned to a particular computing process) and unassigned guest memory (memory that is available to be assigned to a particular computing process. The guest memory may be segregated into individual portions that are assigned to respective computing processes 120A-C. To simplify the illustration, the portions of the guest memory assigned to computing process 120A is illustrated (e.g., guest memory 116) and the portions of guest memory assigned to computing processes 120B and 120C are not shown. During execution of computing process 120A, the guest memory 116 may be updated to add or remove executable data and non-executable data.

During an offload operation, the offload manager 124A-C may copy, from guest memory 116 to host memory, the offloaded task and the execution state of the computing process. The offload request processing component 112 may, using the execution state, create a temporary vCPU and execute the offloaded task. In some implementations, offload manager 124A-C may also create a temporary memory section in guest memory 116 and copy the, to the temporary memory section, the execution state and/or offloaded task. Once the task is executed, the results of the task may be stored in guest memory 116 for offload manager 124A-C to obtain. In some implementations, the temporary vCPU may be subjected to a time-out timer. In some implementations, if the vCPU fails to execute the offloaded task prior to the expiration of the time-out timer, the offload request processing component 112 may store the work completed on the offloaded task in guest memory 116 or send computing process 120A-C an indication that the task failed to complete.

Hardware devices 130 may provide hardware resources and functionality for performing computing tasks. Hardware devices 130 may include one or more physical storage devices 132, one or more physical processing devices 134, other computing devices, or a combination thereof. One or more of hardware devices 130 may be split up into multiple separate devices or consolidated into one or more hardware devices. Some of the hardware device shown may be absent from hardware devices 130 and may instead be partially or completely emulated by executable code.

Physical storage devices 132 may include any data storage device that is capable of storing digital data and may include volatile or non-volatile data storage. Volatile data storage (e.g., non-persistent storage) may store data for any duration of time but may lose the data after a power cycle or loss of power. Non-volatile data storage (e.g., persistent storage) may store data for any duration of time and may retain the data beyond a power cycle or loss of power. In one example, physical storage devices 132 may be physical memory and may include volatile memory devices (e.g., random access memory (RAM)), non-volatile memory devices (e.g., flash memory, NVRAM), and/or other types of memory devices. In another example, physical storage devices 132 may include one or more mass storage devices, such as hard drives, solid state drives (SSD)), other data storage devices, or a combination thereof. In a further example, physical storage devices 132 may include a combination of one or more memory devices, one or more mass storage devices, other data storage devices, or a combination thereof, which may or may not be arranged in a cache hierarchy with multiple levels.

Physical processing devices 134 may include one or more CPUs that are capable of executing the computing tasks. Physical processing devices 134 may be a single core CPU that is capable of executing one instruction at a time (e.g., single pipeline of instructions) or may be a multi-core CPU that simultaneously executes multiple instructions. The instructions may encode arithmetic, logical, or I/O operations. In one example, physical processing devices 134 may be implemented as a single integrated circuit, two or more integrated circuits, or may be a component of a multi-chip module (e.g., in which individual microprocessor dies are included in a single integrated circuit package and hence share a single socket).

Network 140 may be a public network (e.g., the internet), a private network (e.g., a local area network (LAN), a wide area network (WAN)), or a combination thereof. In one example, network 140 may include a wired or a wireless infrastructure, which may be provided by one or more wireless communications systems, such as a wireless fidelity (WiFi) hotspot connected with the network 140 and/or a wireless carrier system that can be implemented using various data processing equipment, communication towers, etc.

FIG. 2 depicts a block diagram illustrating example components and modules of computer system 200 which includes technology for processing an offload request issued by a computing process, in accordance with one or more aspects of the present disclosure. The components and modules discussed herein may be performed by any portion of supervisor 110 (e.g., kernel/hypervisor) or by an application, virtual machine, container, other portion of a computing system, or a combination thereof. More or less components or modules may be included without loss of generality. For example, two or more of the modules may be combined into a single modules, or features of a module may be divided into two or more modules. In one implementation, one or more of the modules may reside on different computing devices (e.g., a client device and a server device).

Computer system 200 may include offload request processing component 210, offload manager 220 and guest memory 116. Guest memory 116, which may include task data 232, indicator data 234, execution state data 236 and results data 238, may be configured by offload request processing component 210 and/or offload manager 220. Task data 232 may include data related to the task desired to be offloaded. Indicator data 234 may be used a location (e.g., memory address) of the task. Execution state data 236 may be used to preserve the execution state of computing process 120A-C. Results data 238 may include data related to the results of executing of the task.

Offload manager 220 be a hardware or software component that issues offload requests (e.g., instructions) to offload request processing component 210. In one example, offload manager 220 may include identification module 222, communication module 224, and merge module 226. Each module may include executable code to perform the one or more functions or processes discussed below. In some embodiments, offload manger 220 may be the same or similar to offload manger 124A-C of FIG. 1.

Identification module 222 may identify one or more task to offload to a supervisor (e.g., supervisor 110). In some implementations, a candidate task for offloading can include a task or thread that can be executed independent of or in parallel with other tasks or threads. For example, a candidate task may include a POSIX thread (pthread). A pthread is an execution model that exists independently from a language and defines a set of programming language types, function, and constraints. In some implementations, the task can be stored as task data 232 in guest memory 116.

Identification module 222 may store the memory address (e.g., the guest physical address) of the task to guest memory 116 (as indicator data 234). In some implementations, indicator data 234 may be stored in a predetermined register, such as a caller-saved register (e.g., RAX register, RCX register, RDX register, etc.), a general-purpose register (e.g., EAX register, EBX register, ECX register), a callee-saved register (e.g., RBX register, RBP register, RDI register, etc.), etc. In some implementations, the indicator can be included in the offload request sent to the supervisor.

Communication module 224 may inform supervisor 110 (e.g., offload request processing component 210) that a respective computing process 120A-C requests supervisor 110 to execute a task on behalf of the computing process 120A-C. In some implementations, to inform offload request processing 220 of the request, communication module 224 may invoke a specific instruction (e.g., a privileged instruction). A privileged instruction may be related to a specific service requested by computing process 120A-C that can be only executed by supervisor 110, such as offload operations pertaining to an offload request.

In some implementations, the specific instruction may be a VM function (e.g., VMFUNC(1)). Although the VM function is used by way of illustrative example, other types of instructions may be used to initiate the offload request. Invoking the VM function may switch a page table pointer from a current page table structure (e.g., a guest page table) to a special page table structure, execute a listing of privileged instructions, etc.

In some implementations, communication module 214 may modify a memory location (in guest 116) that is assigned to be monitored by offload request processing component 210. In response to the specific memory location being modified, offload request processing component 210 may execute one or more functions to perform the privileged instruction, as will be explained in detail below. In some embodiments, the specific location may consist of a bit flag, a word, a page, etc. In an example, communication module 224 may enable the bit flag (e.g., set to a value of one) to alert offload request processing component 210 that computing process 120A-C is attempting to perform the privileged instruction (e.g., offload request), thereby triggering a response from offload request processing component 210, which will be explained in detail below.

Offload request processing component 210 be a hardware or software component that enables supervisor 110 to process offload requests issued by computing processes 120A-C. In one example, offload request processing component 210 may include access module 212, preservation module 214, and execution module 216. Each module may include executable code to perform the one or more functions or processes discussed below. In some embodiments, offload request processing component 210 may be the same or similar to offload request processing component 112 of FIG. 1.

In response to identifying that computing process 120A-C requested offloading a task (e.g., determining that offload manager 220 invoked a VM function), access module 212 may determine whether the computing process 120A-C is allowed (or enabled) to request offloading operations. For example, access module 212 may perform a lookup in a configuration file, in a data table, etc., for an access indicator (e.g., a bit, a flag, etc.) indicative of whether the computing process 120A-C is granted access to the offloading operations. In some implementations, access to offloading operations may be granted by a supervisor, by a computing process, etc.

Responsive to determining that the computing process 120A-C is granted access to offloading operations, access module 212 may determine whether a physical processing device 134 (e.g., CPU) is available for the offload request. In some implementations, access module 212 may lookup whether one or more CPUs are unassigned, idle, etc. In some implementation, access module 212 may enforce a minimum available limit. The minimum available limit may indicate a minimum amount of CPUs that are to be held in reserve by supervisor 110. As such, the number free CPUs that exceed the minimum available limit can be used for offload requests. For example, if supervisor 110 manages sixteen CPUs, the minimum available limit is set to two CPUs, and twelve CPUs are busy (e.g., executing tasks, scheduled to execute tasks, etc.), then two of the sixteen CPUs may be assigned for offload operations.

Responsive to determining that one or more CPUs are available for offload requests, access module 212 may assign one or more of the available CPUs for processing the offloaded task. In some implementations, access module 212 may set a timer for the available CPU(s). The timer may reflect the predetermined maximum allowed time the CPU(s) is available to computing process 120A-C for offload operations. Upon expiration of the timer, access module 212 may terminate assignment of the assigned CPU(s). This will be explained in greater detail below.

Preservation module 214 may store the execution state of computing process 120A-120C. In one example, storing the execution state of computing process 120A-C may include one or more of the storing the memory state of computing process 120A-C, storing the virtual processor (vCPU) state of computing process 120A-C, storing the connectivity state of computing process 120A-C, etc. Preservation module 214 may store the execution state by recording data related to the execution state in execution state data 236. In some implementations, offload manager 220 may store the execution state of computing process 120A-C. In such implementations, since execution state data 236 resides in guest memory 116, supervisor 110 may access execution data 236. In some implementations, the preservation module 214 may set up a page table record such that the assigned CPU is pointed to the guest memory location storing the task.

In some implementations, preservation module 214 may assign a specific memory section of guest memory for execution of the task. For example, the specific memory section may be an assigned or unassigned portion of guest memory 116. Preservation module 214 may then copy the task and/or execution state of computing process to this specific memory section of guest memory. In some implementations, preservation module 214 may record a mapping of the specific memory section in a page table structure. For example, the record may indicate a mapping of the guest physical address to the host physical address where the task is and/or execution state are stored.

Execution module 216 may execute the task on the assigned CPU. In some implementations, execution module 216 may generate a temporary vCPU and assign the temporary vCPU to execute the task on the assigned CPU. Execution module 216 may then load the task data 232 onto the vCPU. For example, execution module 216 may assign or schedule the offloaded task to execute on the CPU.

Once execution of the task is completed, execution module 216 may store, as results data 238, the results obtained from the execution. In some implementations, the timer may expire prior to completion of the task. In such implementations, execution module 216 may store, as results data 238, the incomplete results obtained from the partial execution of the task or store no results. Once execution of the task is complete (or the timer expires), execution module 216 may erase the temporary vCPU and record an indication that the physical CPU as available. For example, the supervisor may maintain a metadata table indicative of the status of each CPU. Execution module 216 may record, in the metadata table, the indication that the physical CPU is available.

Merge module 226 may obtain the results from execution of the offloaded task. In some embodiments, merge module 226 may use a polling technique to repeatedly poll offload processing component 210 for the status of the offloading operations (e.g., whether the task has been completed, timed out, etc.). In some implementations, merge module 226 may periodically or upon expiration of a timer check guest memory 116 for the results data. In some implementation, merge module 226 may periodically poll a specific location in guest memory used to indicate whether the execution of the offloaded task is complete. For example, supervisor 110 may indicate (by flipping a bit, setting a flag, etc. in the specific memory location) when the offloaded task is complete. Merge module 226 may periodically poll this specific memory location and, in response to detecting the indication that the offloaded task is complete, obtain the results. It is noted that, while waiting for the results of the offloaded task, computing process 120A-C may execute other tasks on their assigned processing resources.

In some implementations, upon obtaining the results or receiving an indication that the offloaded task timed-out, merge module 226 may invoke another VM function to switch the page table pointer from index table 114 back to the guest page table structure. In some implementations, merge module 226 may invoke the VM function to switch the page table pointer from index table 114 to the guest page table structure upon expiration of an internal timer, a completion of another task, etc.

Upon obtaining the results data (or partial results data), merge module 226 may analyze the results data to determine whether the offloaded task has been successfully completed. Responsive to determining that the offloaded task has been successfully completed, merge module 226 may incorporate the results data into its operations. In implementations where the execution module 216 generated partial results data (e.g., due to expiration of the timer), merge module 226 may request offload request processing component 210 to perform the task again (e.g., initiate another offload request for the task), request offload request processing component 210 to continue processing the task (e.g., initiate another offload request for the task with modified task data 232 and/or modified executions state data 236 reflective of the partial results obtained), or execute the task (or finish the task) using one or more CPUs assigned to respective computing process 120A-C.

In some implementations, responsive to supervisor 110 failing to identify an available CPU for performing the offloaded task, offload request processing component 210 may put the offloading request function to sleep, and schedule the offloaded task for execution on a CPU initially assigned to computing process 120A-C. Once the offloaded task is complete, supervisor 110 may wake up the offloading request function, such that merge module 226 obtains, from guest memory 116, the results data 238. This may prevent the computing process from experiencing an error condition where the supervisor 110 indicates that the offload request cannot be completed.

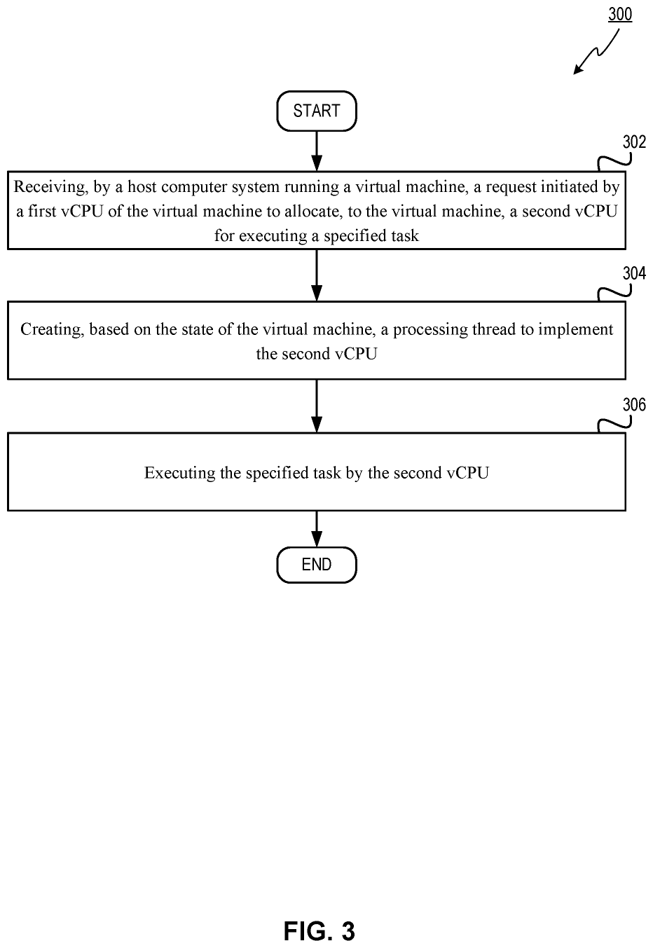

FIG. 3 depicts a flow diagram of an illustrative example of a method 300 for offloading a guest task to a host system, in accordance with one or more aspects of the present disclosure. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processes implementing method 300 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by a computing process (e.g., a virtual machine) as shown in FIG. 1 or by an executable code of a host machine (e.g., host operating system or firmware), a supervisor, a kernel, a guest operating system or virtual firmware, other executable code, or a combination thereof.

Method 300 may be performed by a one or more processing devices of a computing process and/or a host computer system (e.g., a supervisor) and may begin at operation 302. At operation 302, a host machine running a virtual machine may receive a request initiated by an assigned vCPU (a first vCPU) of the virtual machine to allocate, to the virtual machine, another vCPU (a second vCPU) for executing a specified task. In some implementations, the virtual machine may signal the request to execute the specified task on the second vCPU by invoking a VM function (e.g., VMFUNC(1)). In some implementations, the virtual machine may indicate, to the host computer system, a memory address of the specified task by storing the memory address in a register (e.g., an EAX register).

At operation 304, the host computer system may create, based on the state of the virtual machine, a processing thread to implement the second vCPU. In some implementations, the computer host system may initiate a timer reflecting a maximum allowed time the second vCPU is made available to execute the specified task. In implementations where the host computer system fails to identify an unassigned physical CPU on which to provision a vCPU, the host system may schedule the particular task to execute on a physical CPU or vCPU assigned to the virtual machine.

At operation 306, the host computer system may execute the specified task by the second vCPU. In some implementations, the host system may signal completion of the specified task by performing an operation to switch the page table pointer from a special page table structure to the guest page table structure. In some implementations, the virtual machine may receive data obtained from the execution of the specified task and, responsive to determining that the specified task is partially completed, request another vCPU to complete the task. Responsive to completing the operations described herein above with references to operation 306, the method may terminate.

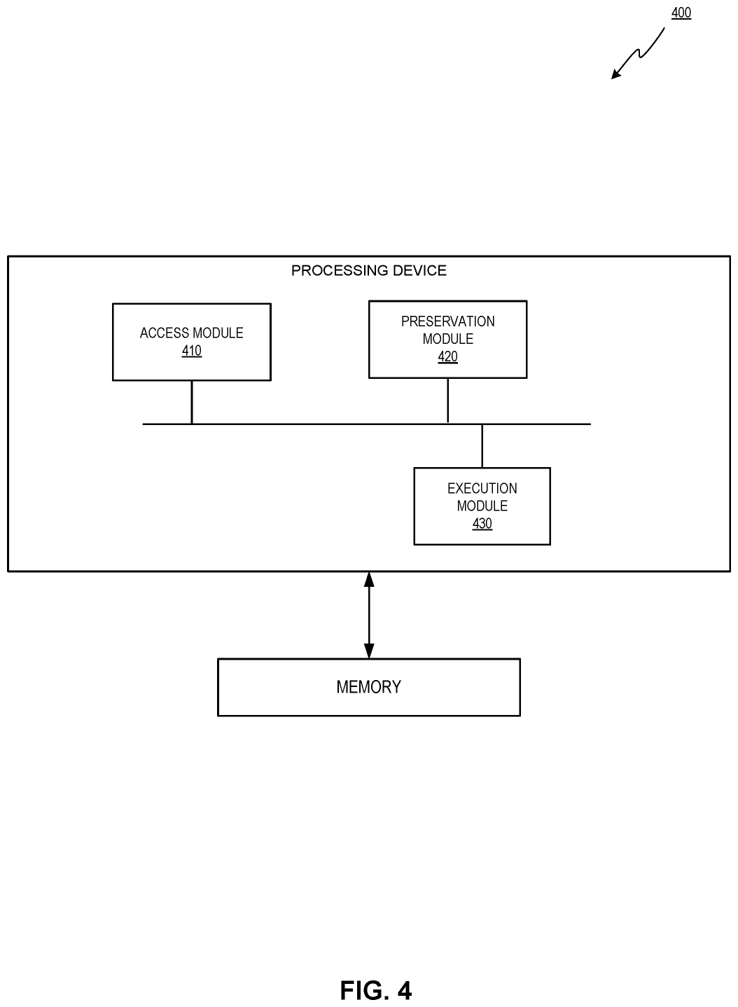

FIG. 4 depicts a block diagram of a computer system 400 operating in accordance with one or more aspects of the present disclosure. Computer system 400 may be the same or similar to computing process 120A-C, offload request processing component 212 and computer system 100 and may include one or more processing devices and one or more memory devices. In the example shown, computer system 400 may include preservation module 410, communication module 420, and operation module 430.

Access module 410 may receive a request, initiated by an assigned vCPU (a first vCPU) of a virtual machine to allocate, to the virtual machine, another vCPU (a second vCPU) for executing a specified task. In some implementations, the virtual machine may signal the request to execute the specified task on the second vCPU by invoking a VM function (e.g., VMFUNC(1)). In some implementations, the virtual machine may indicate, to access module 410, a memory address of the specified task by storing the memory address in a register (e.g., an EAX register). In some implementations, access module 410 may initiate a timer reflecting a maximum allowed time the second vCPU is made available to execute the specified task.

Preservation module 420 may store the execution state of the virtual machine. Execution module 430 may create, based on the execution state of the virtual machine, a processing thread to implement the second vCPU. Execution module 430 may then execute the specified task by the second vCPU. In some implementations, execution module 430 may signal completion of the specified task by performing an operation to switch the page table pointer from a special page table structure to the guest page table structure. In some implementations, the virtual machine may receive data obtained from the execution of the specified task and, responsive to determining that the specified task is partially completed, request another vCPU to complete the task. In implementations where access module 410 fails to identify an unassigned physical CPU on which to provision a vCPU, execution module may schedule the particular task to execute on a physical CPU or vCPU assigned to the virtual machine.

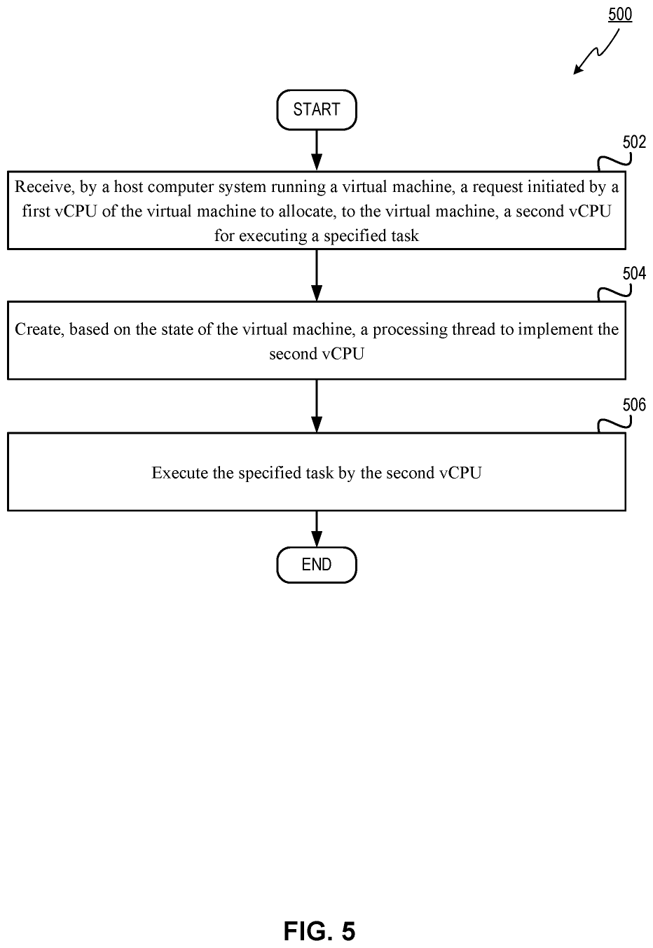

FIG. 5 depicts a flow diagram of one illustrative example of a method 500 for offloading a guest task to a host system, in accordance with one or more aspects of the present disclosure. Method 500 may be similar to method 300 and may be performed in the same or a similar manner as described above in regards to method 300. Method 500 may be performed by processing devices of a server device or a client device and may begin at operation 502.

At operation 502, a processing device may receive a request initiated by a vCPU (a first vCPU) assigned to a virtual machine to allocate, to the virtual machine, another vCPU (a second vCPU) for executing a specified task. In some implementations, the processing device may signal the request to execute the specified task on the second vCPU by invoking a VM function (e.g., VMFUNC(1)). In some implementations, the processing device may indicate, to a host computer system running the virtual machine, a memory address of the specified task by storing the memory address in a register (e.g., an EAX register).

At operation 504, the processing device may create, based on the state of the virtual machine, a processing thread to implement the second vCPU. In some implementations, the processing device may initiate a timer reflecting a maximum allowed time the second vCPU is made available to execute the specified task. In implementations where the processing device fails to identify an unassigned physical CPU on which to provision a vCPU, the processing device may schedule the particular task to execute on a physical CPU or vCPU assigned to the virtual machine.

At operation 506, the processing device may execute the specified task by the second vCPU. In some implementations, the processing device may signal completion of the specified task by performing an operation to switch the page table pointer from a special page table structure to the guest page table structure. In some implementations, the virtual machine may receive data obtained from the execution of the specified task and, responsive to determining that the specified task is partially completed, request another vCPU to complete the task. Responsive to completing the operations described herein above with references to operation 506, the method may terminate

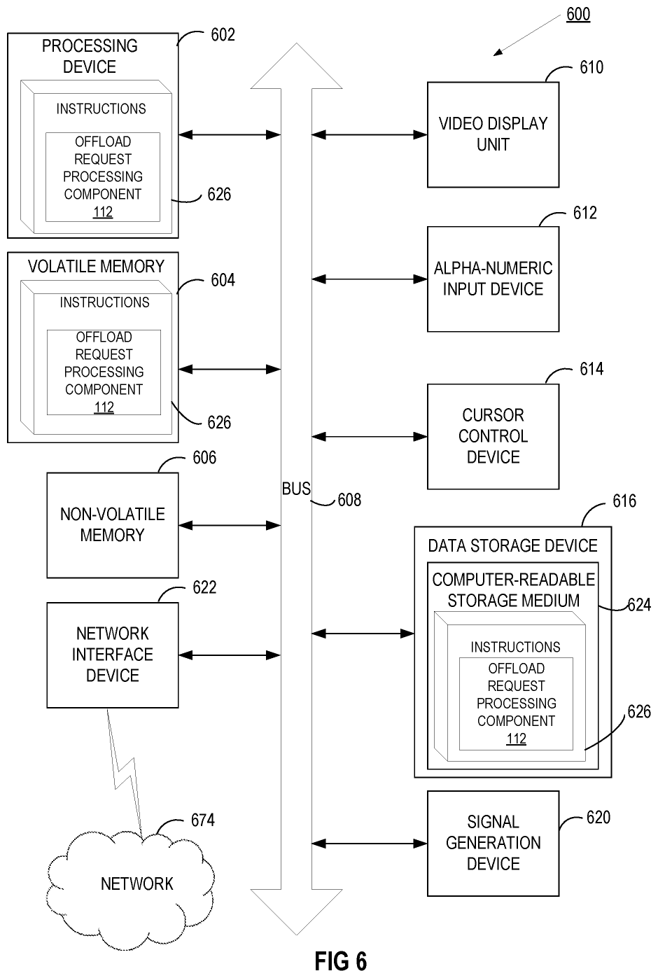

FIG. 6 depicts a block diagram of a computer system operating in accordance with one or more aspects of the present disclosure. In various illustrative examples, computer system 600 may correspond to computing device 100 of FIG. 1 or computer system 200 of FIG. 2. The computer system may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for implementing methods 300 or 500, and for offload request processing component 112 and offload manager 124A-C (not shown), and modules illustrated in FIGS. 1 and 2.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “initiating,” “transmitting,” “receiving,” “analyzing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 or 500 and one or more of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving, by a host computer system running a virtual machine, a request initiated by a first vCPU of the virtual machine to allocate, to the virtual machine, a second vCPU for executing a specified task;
creating, based on the state of the virtual machine, a processing thread to implement the second vCPU; and
executing the specified task by the second vCPU.

2. The method of claim 1, further comprising:
signaling, by the virtual machine, the request to execute the specified task on the second vCPU by invoking a virtual machine function (VMFUNC).

3. The method of claim 1, further comprising:
signaling, by the host computer system, completion of the specified task by storing a value to a memory location shared with the virtual machine.

4. The method of claim 1, further comprising:
indicating a memory address of the specified task by recording a mapping in a page table.

5. The method of claim 1, further comprising:
initiating, by the computer host system, a timer reflecting a maximum allowed time the second vCPU is made available to execute the specified task.

6. The method of claim 1, further comprising:
responsive to failing to identify an unassigned physical CPU, scheduling, by the host system, the specified task to execute on a vCPU assigned to the virtual machine.

7. The method of claim 1, further comprising:
receiving, by the virtual machine, data obtained from the execution of the specified task; and
responsive to determining that the specified task is partially completed, requesting another vCPU to complete the task.

8. A system, comprising:
a memory;
a processing device operatively coupled to the memory, the processing device configured to:
receive, by a host computer system running a virtual machine, a request initiated by a first vCPU of the virtual machine to allocate, to the virtual machine, a second vCPU for executing a specified task;
create, based on the state of the virtual machine, a processing thread to implement the second vCPU; and
execute the specified task by the second vCPU.

9. The system of claim 8, the processing device further configured to:
signal, by the virtual machine, the request to execute the specified task on the second vCPU by invoking a virtual machine function (VMFUNC).

10. The system of claim 8, the processing device further configured to:
signal completion of the specified task by storing a value to a memory location shared with the virtual machine.

11. The system of claim 8, the processing device further configured to:
indicate a memory address of the specified task by recording a mapping in a page table.

12. The system of claim 8, the processing device further configured to:
initiate, by the computer host system, a timer reflecting a maximum allowed time the second vCPU is made available to execute the specified task.

13. The system of claim 8, the processing device further configured to:
responsive to failing to identify an unassigned physical CPU, schedule, by the host system, the specified task to execute on a vCPU assigned to the virtual machine.

14. The system of claim 8, the processing device further configured to:
receive, by the virtual machine, data obtained from the execution of the specified task; and
responsive to determining that the specified task is partially completed, request another vCPU to complete the task.

15. A non-transitory machine-readable storage medium storing executable instructions that, when executed by a processing device, cause the processing device to:
receive, by a host computer system running a virtual machine, a request initiated by a first vCPU of the virtual machine to allocate, to the virtual machine, a second vCPU for executing a specified task;
create, based on the state of the virtual machine, a processing thread to implement the second vCPU; and
execute the specified task by the second vCPU.

16. The non-transitory machine-readable storage medium of claim 15, further comprising instructions that cause the processing device to:
signal, by the virtual machine, the request to execute the specified task on the second vCPU by invoking a virtual machine function (VMFUNC).

17. The non-transitory machine-readable storage medium of claim 15, further comprising instructions that cause the processing device to:
signaling completion of the specified task by storing a value to a memory location shared with the virtual machine.

18. The non-transitory machine-readable storage medium of claim 15, further comprising instructions that cause the processing device to:
indicate a memory address of the specified task by recording a mapping in a page table.

19. The non-transitory machine-readable storage medium of claim 15, further comprising instructions that cause the processing device to:
initiate, by the computer host system, a timer reflecting a maximum allowed time the second vCPU is made available to execute the specified task.

20. The non-transitory machine-readable storage medium of claim 15, further comprising instructions that cause the processing device to:
responsive to failing to identify an unassigned physical CPU, schedule, by the host system, the specified task to execute on a vCPU assigned to the virtual machine.
